(19) United States
(12) Patent Application Publication
(10) Pub. No.: US 2005/0029085 A1
(43) Pub. Date: Feb. 10, 2005

(54) Switch for vehicle

(76) Inventors: Shigetaka Dozono, Fukui (JP); Manabu Shiroshita, Fukui (JP); Hiroyuki Kosaka, Fukui (JP)

Correspondence Address: WENDEROTH, LIND & PONACK, L.L.P., 2033 K STREET N. W., SUITE 800, WASHINGTON, DC, 20006-1021, US

(21) Appl. No.: 10/877,978

(22) Filed: Jun. 29, 2004

(30) Foreign Application Priority Data
Aug. 5, 2003 (JP) 2003-286660

(51) Int. Cl. H01H 9/00

(52) U.S. Cl. 200/520

(57) ABSTRACT

The present invention can provide a switch for vehicle used to detect opening/closing of a car door or the like with a nice operation feeling and stable performances. A plurality of thin corrugated sections 16A is provided on cover 16 that covers the switching-element, connection points of the lead wires and lower portions of the cases. The switch for vehicle performs a nice operation feeling with quick response, as upon pushing the cap, corrugated sections 16A of cover 16 expand outward to prevent air in the switch from being compressed.

### FIELD OF THE INVENTION

The present invention relates to a switch for vehicle mounted mainly in car to detect opening/closing of car doors or the like.

### BACKGROUND ART

Nowadays, most cars have switch for vehicle (hereafter referred to as switch) mounted in car doors to control switching of room lights or to detect locking of doors according to opening/closing of the doors.

The switch is typically covered with rubbers for waterproofing as the switch is mounted in a position of a door apt to getting wet by raindrops or the like when the door is open.

The conventional switch is described with reference to FIGS. 5 and 6. FIG. 5 shows a cross-sectional view of a conventional switch. FIG. 6 shows car 40 as an example of vehicles.

Upper portion of substantially cylindrical shaped inner case 2 made of insulation resins is fitted securely into substantially cylindrical shaped outer case 1 made of insulation resins as shown in FIG. 5. Stationary contacts 3 and 4 made of conductive metals are disposed facing each other on right and left hand side inner wall surfaces of inner case 2. Substantially U-shaped movable contact 6 made of conductive metals is mounted on operating body 5. Both ends of movable contact 6 attach to stationary contacts 3 and 4 resiliently. Movable contact 6 thus forms a switching-element to connect/disconnect stationary contacts 3 to 4 electrically.

Rubber cap 7 is disposed on the top surface of outer case 1 covering the top of operating body 5 that protrudes out of an aperture of outer case 1 to prevent raindrops from coming into gaps between the aperture and operating body 5. Coiled spring 8 is mounted between the bottom surface of operating body 5 and the base surface of inner case 2 in a slightly sagging condition, causing operating body 5 to bias upward.

The top ends of a plurality of conductive metal lead wires 9 coated with insulation resins or the like are connected to the bottom ends of stationary contacts 3 and 4 that extend out of the bottom surface of inner case 2 via conductive metal connector 10.

While the upper portion of rubber cover 11 placed in contact with the periphery of lower portion of outer case 1 covers the bottom ends of stationary contacts 3 and 4, the top ends of lead wires 9 and connector 10, lead wires 9 that has been pressed into the bottom surface of cover 11 extend downward.

Namely, cover 11 covers; the bottom ends of stationary contacts 3 and 4 extending out of the bottom surface of inner case 2, conductive portion of connector 10 or the like that couples stationary contacts 3 and 4 with lead wires 9, and slight gaps of the fitting portion of inner case 2 to outer case 1. The conductive portions of the switch are thus prevented from moisture condensation or water infiltration.

The switch is mounted in door part 20 of car door 30, with bottom ends of lead wires 9 being connected to electronic circuits (not shown) of car 40.

Upon closing car door 30, door part 20 pushes the top of operating body 5 while depressing cap 7 causing operating body 5 to move downward while depressing spring 8.

Then both ends of movable contact 6 mounted on operating body 5 depart from stationary contacts 3 and 4, and attach right and left hand side inner wall surfaces of inner case 2 resiliently, causing the switching-element to open and for instance room lights turn off.

On the other hand, upon opening car door 30, door part 20 releases operating body 5 from the pushing force. Subsequently, a biasing force of spring 8 moves movable contact 6 upward with operating body 5, causing both ends of movable contact 6 to attach stationary contacts 3 and 4 resiliently, thereby causing the switching-element to close and for instance room lights or the like turn on.

As aforementioned, the switch configuration has a function capable of controlling room lights or the like or checking door locking according to opening/closing detection of car doors.

Japanese Patent Unexamined Application No. 2003-146077 discloses the switch with such a configuration.

In the conventional technology, however, while cap 7 is depressed by pushing operation air trapped in cap 7 that has no vent is compressed as the switch is sealed air-tight internally by cap 7 and cover 11. As a result, the drawback is that the switch cannot operate in quick response, and cap 7 and operating body 5 are apt to return unstably after the pushing is released.

The present invention aims at solving the conventional problems and can provide a switch for vehicle with an excellent operating feeling and stable switching performances.

### SUMMARY OF THE INVENTION

A switch for vehicle disclosed in this invention comprises: substantially cylindrical shaped cases; an operating body housed in the cases upward and downward movably; a switching-element to connect/disconnect electrically according to the upward and downward movements of the operating body; lead wires connected to the switching-element and extending externally; and a cover that covers the switching-element, connection points of the lead wires and lower portions of the cases; wherein the cover is provided with a plurality of thin corrugated sections.

Moreover, the vehicle switch disclosed further comprises: substantially cylindrical shaped cases; an operating body housed in the cases upward and downward movably; a switching-element to connect/disconnect electrically according to the upward and downward movements of the operating body; lead wires connected to the switching-element and extending externally; and a cover that covers the switching-element, connection points of the lead wires and lower portions of the cases; wherein the cover is provided with a hollow tube extending externally.

### BRIEF DESCRIPTION OF THE DRAWINGS

FIG. 1 shows a cross-sectional view of a switch for vehicle used in preferred embodiment 1 of the present invention.

FIG. 2 shows an exploded perspective view of a switch for vehicle used in preferred embodiment 1 of the present invention.

FIG. 3 shows a cross-sectional view of a switch for vehicle under depressed condition used in preferred embodiment 1 of the present invention.

FIG. 4 shows a cross-sectional view of a switch for vehicle used in preferred embodiment 2 of the present invention.

FIG. 5 shows a cross-sectional view of a conventional switch for vehicle.

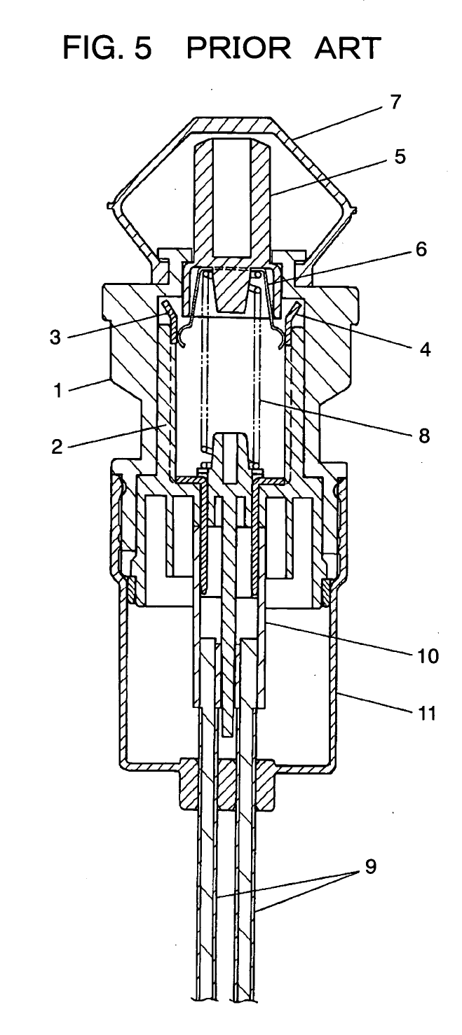

FIG. 6 shows a perspective view of a car as an example of vehicles.

### DETAILED DESCRIPTION OF PREFERRED EMBODIMENTS

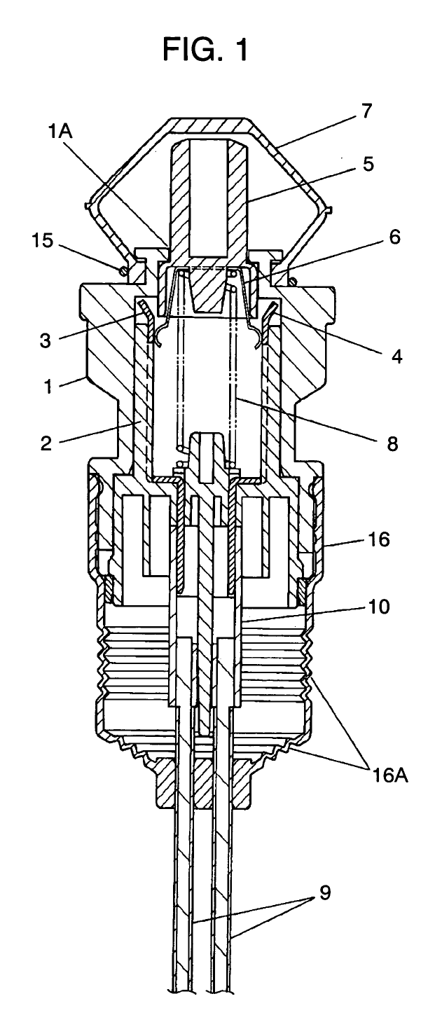

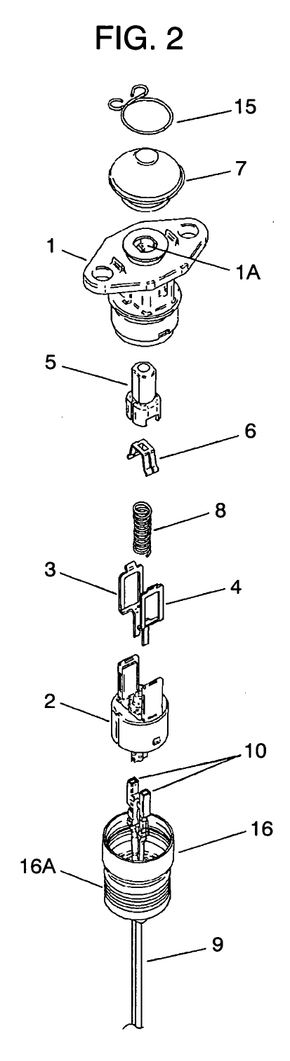

The preferred embodiments of the present invention are described with reference to FIGS. 1 to 4. The drawings are schematic that do not show the positions and dimensions correctly. The similar elements described in the conventional art have the same reference marks and the detailed description thereof is omitted.

(Preferred Embodiment 1)

Substantially cylindrical shaped outer case 1 and inner case 2 are made of insulation resins such as polyacetal, polybutylene terephthalate (PBT) or the like. Upper portion of inner case 2 is fitted securely in outer case 1. Stationary contacts 3 and 4 made of conductive metals such as copper alloys or the like are disposed facing each other on right and left hand side inner wall surfaces of inner case 2.

Operating body 5 made of insulation resins such as polyacetal, polyamide or the like is housed movable upward and downward freely in case 2. Both ends of substantially U-shaped movable contact 6, made of conductive metals such as copper alloys or the like, attach to stationary contacts 3 and 4 resiliently. Movable contact 6 thus forms a switching-element to connect/disconnect stationary contact 3 to stationary contact 4 electrically.

Cap 7 made of rubber or elastomer is mounted at the periphery of aperture 1A on the top surface of outer case 1, being clamped by an elastic ring 15 made of steel wire or the like. Covering the top of operating body 5 that protrudes out of aperture 1A, cap 7 inhibits the infiltration of water through gaps between aperture 1A and periphery of operating body 5.

Coiled spring 8 made of steel wire or the like is mounted between the bottom surface of operating body 5 and the base surface of inner case 2 in a slightly sagging condition, causing operating body 5 to bias upward. A plurality of lead wires 9 is made of conductive metal wires coated with insulation resins such as polyethylene, polyvinyl chloride or the like. The top ends of a plurality of lead wires 9 are connected to the bottom ends of stationary contacts 3 and 4 extending out of the bottom surface of inner case 2 via conductive metal connector 10 made of copper alloys or the like.

Cover 16 is made of rubber or elastomer. Example of rubber includes chloroprene rubber, NBR, ethylene-propylene rubber and silicone rubber or the like. Example of elastomer includes polyamide system elastomer, urethane elastomer and silicone elastomer or the like. The upper portion of cover 16 is appressed to the lower portion of outer case 1, covering the lower ends of stationary contacts 3 and 4, the top ends of lead wires 9 and connector 10. Lead wires 9 that have been pressed into the bottom surface of cover 16 extend downward.

Moreover, cover 16 is provided with a plurality of thin corrugated sections 16A in its central and lower portions. Cover 16 covers: the bottom ends of stationary contacts 3 and 4 that extend out of the bottom surface of inner case 2; conductive portion of connector 10 or the like that couples stationary contacts 3 and 4 with lead wires 9; and slight gaps in the fitting portion of inner case 2 to outer case 1. The configuration thus inhibits moisture condensation on internal conductive parts or water infiltration to the switch.

The switch is mounted in door part 20, with the bottom ends of lead wires 9 connected to electronic circuits (not shown) of the car.

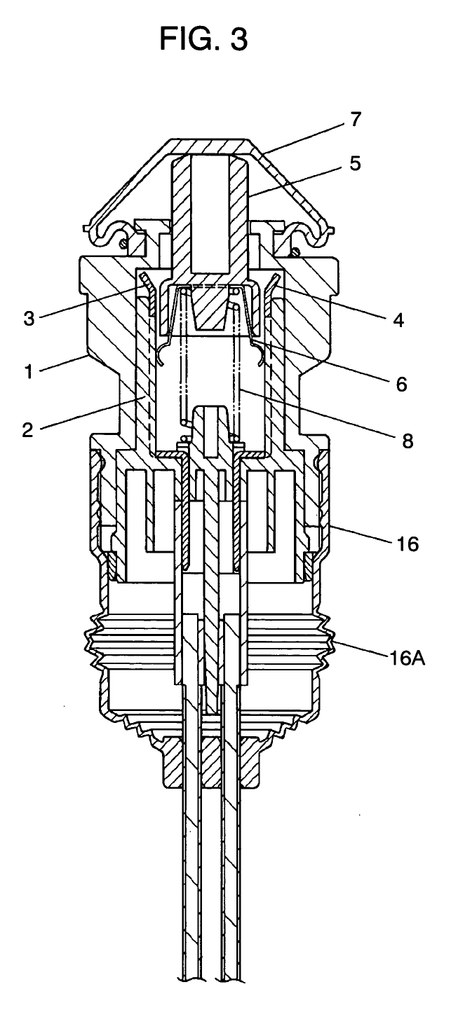

Upon closing car door 30, door part 20 will push the top of operating body 5 while depressing cap 7. Then, the downward movement of operating body 5 while depressing spring 8 causes both ends of movable contact 6 mounted on operating body 5 to depart from stationary contacts 3 and 4 as shown in the cross-sectional view in FIG. 3. Subsequently, both ends of movable contact 6 attach to right and left hand side inner wall surfaces of inner case 2 resiliently, causing the switching-element to open and for instance room lights turn off.

At this time, being compressed by the pushing operation, internal air of cap 7 flows into cover 16 from slight gaps in the fitting portion of inner case 2 to outer case 1 through inner case 2, which causes cover 16 to increase in internal air pressure. However, thin corrugated sections 16A provided in the central and lower portions of cover 16 expand outward corresponding to the increased air pressure as shown in FIG. 3. As a result, the configuration can prevent a force needed to move operation body 5 via cap 7 from increasing. The increase of the force is caused by the internal compressed air of the switch.

On the other hand, upon opening car door 30, door part 20 departs from operating body 5 while releasing the pushing force. Subsequently, a biasing force of spring 8 moves movable contact 6 upward with operating body 5, causing both ends of movable contact 6 to attach stationary contacts 3 and 4 resiliently, thereby causing the switching-element to close and room lights or the like turn on as shown in FIG. 1.

At this time, along with cap 7 returning to an initial state, corrugated sections 16A of cover 16, once expanded, also returns to an initial state as air trapped in cover 16 will flow back into cap 7 through inner case 2.

Upon pushing cap 7, corrugated sections 16A of cover 16 expand outward. The configuration can prevent a force needed to move operation body 5 via cap 7 from increasing. The increase of the force is caused by the internal compressed air of the switch. Upon releasing cap 7, operating body 5 and cap 7 can return to the initial state smoothly by flowing air trapped in cover 16 back into cap 7.

As mentioned above, the switch described in this embodiment has cover 16, covering the switching-element, connection points of lead wires 9 and lower portions of the case, is provided with a plurality of thin corrugated sections 16A. The configuration can, therefore, provide the switch with a nice operation feeling and stable performances as air trapped in the switch is not compressed due to corrugated sections 16A expanding outward, upon pushing of cap 7.

(Preferred Embodiment 2)

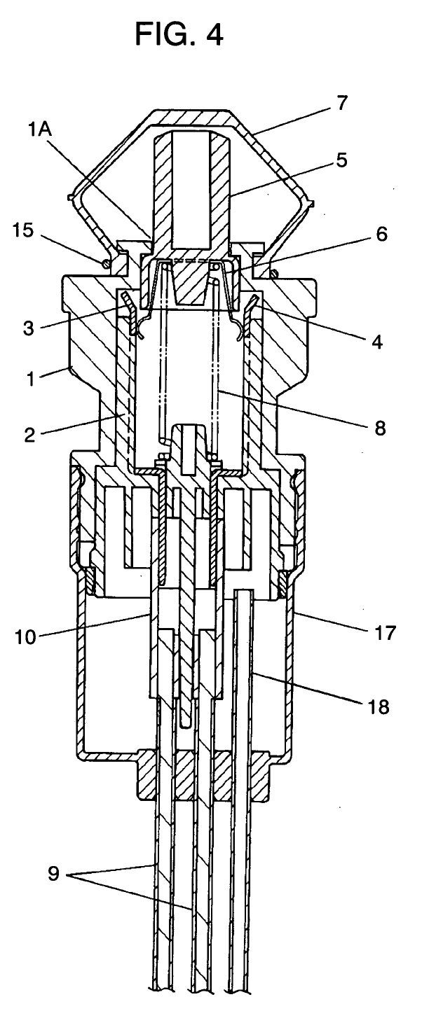

Preferred embodiment 2 is described with reference to FIG. 4. The similar elements described in preferred embodiment 1 have the same reference marks and the detailed description thereof is omitted.

In FIG. 4, the followings are similar to preferred embodiment 1: that the upper portion of inner case 2 is fitted securely into outer case 1, and stationary contacts 3 and 4 are disposed facing each other on right and left hand side inner wall surfaces of inner case 2; and that both ends of movable contact 6 attach to stationary contacts 3 and 4 resiliently to form a switching-element.

Moreover, the followings are similar to preferred embodiment 1: that cap 7 is mounted clamped by an elastic ring 15 at the periphery of aperture 1A on the top surface of outer case 1; that coiled spring 8 is mounted between the bottom surface of operating body 5 and the base surface of inner case 2 in a slightly sagging condition, causing operating body 5 to bias upward; and that the top ends of lead wires 9 are connected to the bottom ends of stationary contacts 3 and 4 extending out of the bottom surface of inner case 2 via connector 10.

Additionally, the followings are similar to preferred embodiment 1: that the top of cover 17 made of rubber or elastomer is appressed to the lower portion of outer case 1, covering the lower ends of stationary contacts 3 and 4, the top ends of lead wires 9 and connector 10; and that lead wires 9 that have been pressed into the bottom surface of cover 17 extend downward.

The difference from preferred embodiment 1 is that hollow tube 18 made of insulation resins such as polyethylene, polyvinyl chloride or the like is also pressed into the bottom surface of cover 17. The top end of hollow tube 18 is disposed in the internal space of cover 17, and the bottom end extends out of the bottom surface of cover 17 accompanying lead wires 9.

The switch with the configuration is mounted in door part 20, with the bottom ends of lead wires 9 connected to electric circuits (not shown) of the vehicle and with the bottom ends of hollow tube 18 extended to a position of the vehicle free from rainwater or the like.

Upon closing car door 30, door part 20 will push the top of operating body 5 while pushing cap 7, and operating body 5 will move downward while pushing spring 8. Then, departing from stationary contacts 3 and 4, both ends of movable contact 6 mounted on operating body 5 attach to right and left hand side inner wall surfaces of inner case 2 resiliently, causing the switching-element to open and for instance room lights turn off.

At this time, air in cap 7 depressed by the pushing force flows into cover 17 through slight gaps in the fitting portion of inner case 2 to outer case 1 via inner case 2, causing cover 17 to increase in internal air pressure. The internal high pressure air will flow out through hollow tube 18 to a predetermined position of the car. The configuration prevents a force needed to move operation body 5 via cap 7 from increasing. The increase of the force is caused by the internal compressed air of the switch.

Upon opening car door 30, door part 20 departs from operating body 5 while releasing the pushing force, causing movable contact 6 to move upward with operating body 5 by a biasing force of spring 8. Then both ends of movable contact 6 attach stationary contacts 3 and 4 resiliently, causing the switching-element to close and for instance room lights or the like turn on as shown in FIG. 4.

At this time, air is sucked into cover 17 from outside through hollow tube 18 allowing cap 7 to return to the initial state. Namely, the configuration allows operating body 5 and cap 7 to return to the initial states smoothly by exhausting or sucking air in cover 17 through hollow tube 18 according to loading or unloading of pushing force.

As described above, the configuration of embodiment 2 does not compress internal air of the switch due to hollow tube 18 extended out of cover 17 that covers the switching-element, coupling points of lead wires 9 and lower portions of cases.

The configuration can, therefore, provide the switch with a nice operation feeling and stable performances.

Additionally, as described in preferred embodiments 1 and 2, cap 7 mounted clamped by an elastic ring 15 at the periphery of aperture 1A on the top surface of outer case 1 can inhibit the infiltration of water through gaps between aperture 1A and periphery of operating body 5 more reliably.

The switch configuration of the present invention provides the cover that covers the switching-element, connection points of the lead wires and lower portions of the cases with a plurality of thin corrugated sections. The switch can provide a nice operation feeling and stable performances, as upon pushing the cap, corrugated sections 16A of cover 16 expand outward to prevent air in the switch from being compressed.

Moreover, another switch configuration of the present invention provides the cover that covers the switching-element, connection points of the lead wires and lower portions of the cases with a hollow tube extending outward. The switch can provide a nice operation feeling and stable performances, as upon pushing the cap, air in the switch flows out through the hollow tube.

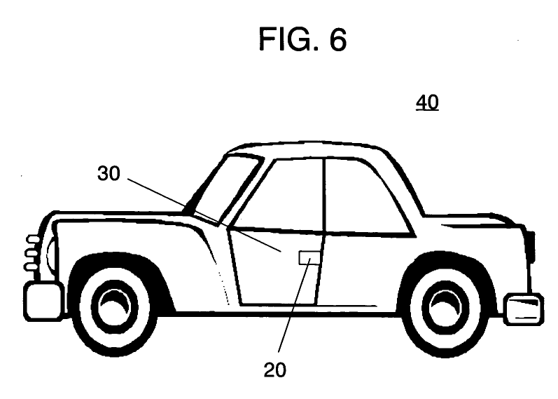

Additionally, the door part to mount the switch of the present invention is not so limited to the portion for instance as shown in FIG. 6.

As described above, the present invention can realize the switch to detect opening/closing of car doors or the like with a nice operation feeling and stable performances.

1. A vehicle switch comprising:
substantially cylindrical shaped cases;
an operating body housed movably upward and downward in the cases;
a switching-element to connect/disconnect electrically according to upward and downward movements of the operating body;
lead wires connected to the switching-element and extending externally; and
a cover to cover the switching-element, connection points of the lead wires and a lower portion of the cases, wherein the cover is provided with a plurality of thin corrugated sections.

2. A vehicle switch comprising:
substantially cylindrical shaped cases;
an operating body housed movably upward and downward in the cases;
a switching-element to connect/disconnect electrically according to upward and downward movements of the operating body;
lead wires connected to the switching-element and extending externally; and
a cover to cover the switching-element, connection points of the lead wires and lower portions of the cases, wherein a hollow tube extends out of the cover.
